(19) United States
(12) Patent Application Publication
(10) Pub. No.: US 2015/0240531 A1
(43) Pub. Date: Aug. 27, 2015

(54) WIRELESS LOCKING SYSTEM AND METHOD

(71) Applicant: LifeStyleLock, LLC, Sharpsburg, GA (US)

(72) Inventors: Richard J Blust, Sharpsburg, GA (US); Donald M. Blust, St. Charles, IL (US)

(21) Appl. No.: 14/634,237

(22) Filed: Feb. 27, 2015

Related U.S. Application Data
(60) Provisional application No. 61/945,586, filed on Feb. 27, 2014.

(51) Int. Cl. E05B 65/52; E05B 47/00; G07C 9/00; E05C 1/00

(52) U.S. Cl. CPC E05B 65/52; E05C 1/00; E05B 47/0001; G07C 9/00309

(57) ABSTRACT

A lockable enclosure system includes a locking mechanism controlled by a wireless device. The locking mechanism can be retrofitted to a container having an enclosure and an openable member that selectively provides access to the enclosure. The locking mechanism is selectively movable from a locked position in which the openable member is held in a closed position to an unlocked position in which the openable member is allowed to be opened to provide access to the enclosure. The locking mechanism includes a wireless communication unit to selectively move the locking mechanism between the locked position and the unlocked position in response to wireless signals received from the wireless device of a user.

### RELATED APPLICATIONS

This application takes priority to U.S. Provisional Patent Application Ser. No. 61/945,586, filed Feb. 27, 2014, and entitled “A High Holding Force Closure Designed to Securely Lock a Cabinet Door, Drawer, or Storage Space Opening to Which it is Applied,” the contents of which is incorporated herein by reference in its entirety.

### FEDERALLY SPONSORED RESEARCH OR DEVELOPMENT

Not Applicable.

### COMPACT DISK APPENDIX

Not Applicable.

### FIELD OF INVENTION

The present invention generally relates to locking devices, and more particularly, to a wireless locking system and method.

### BACKGROUND

A safe, which may be also referred to as a strongbox or coffer, generally refers to a device that may be selectively locked for securement of items from unwanted or illicit access. The safe typically includes a housing that forms an enclosure with a door, or other openable member that selectively provides access to the enclosure using a latch, bolt, or other type of locking mechanism. The housing of the safe is often made of structurally tough, hardened materials, such as thick metal, concrete, plastic, and the like, to resist illicit access to the enclosure by any means other than through that provided by access through the locking mechanism. In some cases, the housing may also include fire retardant materials to mitigate the effects that may be incurred to items within the enclosure caused by fire.

### SUMMARY

According to one embodiment, a lockable enclosure system includes a locking mechanism controlled by a wireless device. The locking mechanism can be retrofitted to a container having an enclosure and an openable member that selectively provides access to the enclosure. The locking mechanism is selectively movable from a locked position in which the openable member is held in a closed position to an unlocked position in which the openable member is allowed to be opened to provide access to the enclosure. The locking mechanism includes a wireless communication unit to selectively move the locking mechanism between the locked position and the unlocked position in response to wireless signals received from the wireless device of a user.

### BRIEF DESCRIPTION OF THE DRAWINGS

FIGS. 1A and 1B illustrate an example lockable enclosure system in an unlocked position and a locked position, respectively, according to the teachings of the present disclosure.

FIGS. 2A and 2B illustrate an example locking device prior to being retrofitted to a container according to the teachings of the present disclosure.

FIG. 3 illustrates several example components of the locking device according to the teachings of the present disclosure.

FIG. 4 is a block diagram showing an example wireless device according to the teachings of the present disclosure.

FIG. 5 illustrates an example process that may be performed by the locking device management application 408 according to the teachings of the present disclosure.

FIGS. 6A through 6C illustrate example graphical user interfaces that may be generated by the locking mechanism management application according to the teachings of the present disclosure.

FIG. 7 illustrates a block diagram of an example computer device for use with the example embodiments.

### DETAILED DESCRIPTION

As described previously, safes provide for the secured enclosure of items from unwanted and/or illicit access. Nevertheless, conventionally available safes have several salient drawbacks that have limited their widespread use. For example, safes often have an appearance and size that readily indicates to would be intruders that valuable or important items may be held inside. To secure the strongboxes against theft, these conventional strongboxes can be mounted to a building in which they are placed, but these mounting mechanisms are only as robust as the building to which they are mounted and can be circumvented by intruders who are aware of the construction practices by which the building is constructed. Furthermore, conventional strongbox designs are not designed to aesthetically contribute to the décor of the inside of a building (e.g., a room of a house, an office, etc.), thus relegating their placement to areas within a building, such as inside of a closet, or hidden behind a picture, and the like.

Some strongbox designs have attempted to conceal their actual purpose using an outer facade that resembles items typically found in an environment in which they are placed (e.g., a book placed on a bookshelf, an aerosol can placed in a cupboard, etc.), but these facades are often readily circumvented by illicit intruders who may be trained to detect such devices. Worse, strongboxes of this type usually have limited enclosure space which may limit the size and number of items to be stored therein. As such, conventionally available strongboxes have enjoyed limited use due to their inability to conceal their purpose as a secure container for valuable or important items, their generally non-aesthetically pleasing appearance, and their limited ability to be secured from theft.

Another drawback of conventional strongbox designs include the access mechanisms used to provide for opening the enclosure in order to secure the items inside. Typical access mechanisms include keys that may be physically brought into contact with the strongbox via insertion into a specified key locking mechanism or other physical actuation mechanisms. Nevertheless, the physical key locking mechanism uses keys that can be misplaced, thus rendering access to the strongbox difficult if not impossible. Additionally, these keys can be stolen, thus providing for easy access by intruders for whom the strongbox is to be secured against. Other access mechanisms include combination codes that involve a particular sequence of numbers or characters that may be entered via a keypad, rotary dial, or other entry mechanism on the strongbox. However, the sequence of numbers or characters may be forgotten, or worse, discovered by the intruder, which would again defeat the purpose of the strongbox to inhibit illicit access by the intruder.

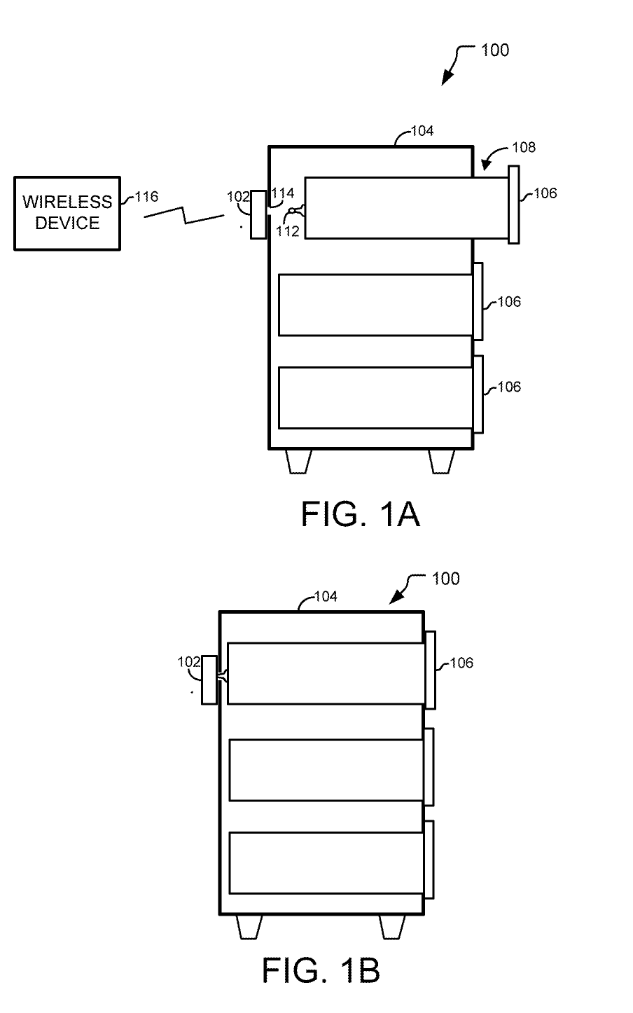

FIGS. 1A and 1B illustrate an example lockable enclosure system 100 according to the teachings of the present disclosure. The lockable enclosure system 100 provides one or more solutions to one or more of the problems associated with conventional strongboxes as described above. The lockable enclosure system 100 includes a locking device 102 that may be retrofitted to a container, which in this particular embodiment is a dresser 104 having at least one drawer 106 that may be selectively locked or unlocked to provide access to an enclosure 108 provided by the drawer 106. Although a dresser 104 having multiple drawers 106 is shown and described herein, it should be understood that other embodiments of the lockable enclosure system 100 may be retrofitted to any suitable container with an openable member, such as a box with a lid, a cupboard with a door, a two-door cabinet, a refrigerator or wine cabinet, a job site box, a food cooler, and the like.

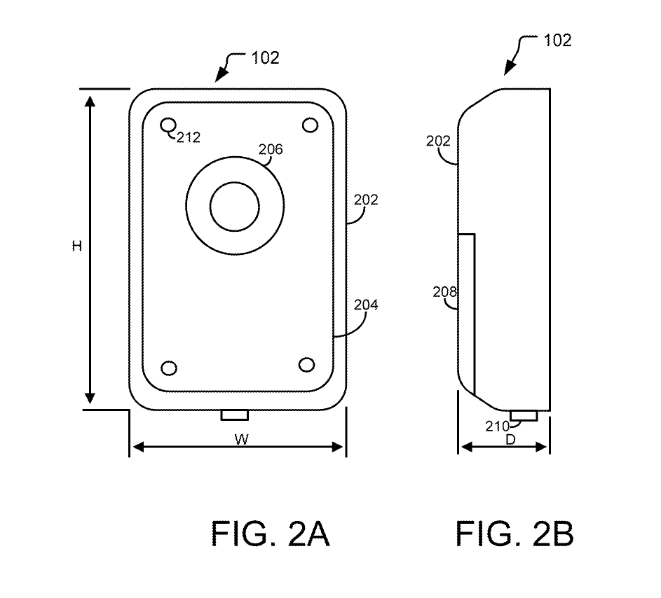

The locking device 102 includes a locking mechanism 206 (FIG. 2A) that is selectively movable from a locked position (FIG. 1B) in which the drawer 106 is held in a closed position to an unlocked position (FIG. 1A) in which the drawer 106 is allowed to be opened to provide for access to the enclosure 108. The locking mechanism 206 includes a pin 112 that is mounted to the drawer 106 and includes an enlarged ball portion extending from the end of the pin. When in the locked position, the enlarged ball portion is configured to extend through a hole 114 formed in a rear wall of the dresser 104 and engage a receptacle portion of the locking mechanism and secured within the receptacle via an actuator, such as a solenoid or other physical actuation mechanism. In other embodiments, the locking mechanism 206 may include any physical structure that selectively holds the drawer 106 or other openable member in a closed position. The locking device 102 is controlled by a wireless device 116 to selectively move the locking mechanism 206 from the locked position to the unlocked position to provide for access to the enclosure of the openable member. In one embodiment, the actuator 306 may be biased in the locked position such that, if electrical power is removed from the locking device 102, the locking mechanism 206 will remain locked until electrical power is restored.

FIGS. 2A and 2B illustrate an example locking device 102 prior to being retrofitted to a container according to the teachings of the present disclosure. The locking device 102 includes a housing 202 and a mounting plate 204 to house a locking mechanism 206 and other associated components inside. The housing 202 may also include a battery access door 208 to provide for access to a battery compartment and/or an alternating current (AC) power receptacle, direct current (DC) power receptacle, or both 210 to receive a power jack to provide for electrical power for the wireless device 102.

The example housing 202 is made of an impact resistant material that resists intrusion. For example, the housing 202 may be made of plastic having approximately 30 percent glass-filled nylon that may remain intact when subjected to multiple hammer strikes. The mounting plate 204 may be formed of alloy steel and includes screw holes 212 to be mounted to the rear wall of the dresser 104. When the locking device 102 is mounted to the rear wall, the screws inserted in the screw holes 212 are accessible only from inside the dresser 104, thus inhibiting the ability to unmount the locking device 102 by an intruder. As shown, the housing 202 has a height (H) of approximately 5.5 inches, a width (W) of approximately 3.5 inches, and depth (D) of approximately 1.5 inches. Nevertheless, other embodiments of the locking device 102 may have any suitable size or structure without deviating from the spirit or scope of the present disclosure.

The wireless device 116 may communicate with the locking device 102 using any suitable protocol. For example, the wireless device 116 may communicate with the locking device 102 directly using radio frequency (RF) energy, such as that provided for licensed and unlicensed wireless communication by the Federal Communications Commission (FCC) under Title 47, Part 15 of the Code of Federal Regulations. Other communication protocols, such as Bluetooth™, Bluetooth™ low energy (BLE), Wi-Fi, ZigBee, Z-Wave, and the like, may also be used for direct communication. As another example, the wireless device 116 may communicate with the locking device 102 using indirect communication, such as one in which communication between the wireless device 116 and the locking device 102 is provided by a network, such as a packet network (e.g., the Internet) or a cellular phone based network. The wireless device 116 and the locking device 102 may communicate data in packets, messages, or other communications using a common protocol, e.g., Hypertext Transfer Protocol (HTTP) and/or Hypertext Transfer Protocol Secure (HTTPS). The wireless device 116 and the locking device 102 may communicate based on representational state transfer (REST) and/or Simple Object Access Protocol (SOAP). As an example, the wireless device 116 may send a request message that is a REST and/or a SOAP request formatted using Javascript Object Notation (JSON) and/or Extensible Markup Language (XML). In response to the request message, the locking device 102 may transmit a REST and/or SOAP response formatted using JSON and/or XML. As an example, the wireless device 116 and the locking device 102 may communicate using a web application programming interface (API) comprising a defined request/response message system. According to one aspect, the message system is based on Javascript Object Notation (JSON) and the web API is a RESTful web API based on Representational State Transfer (REST).

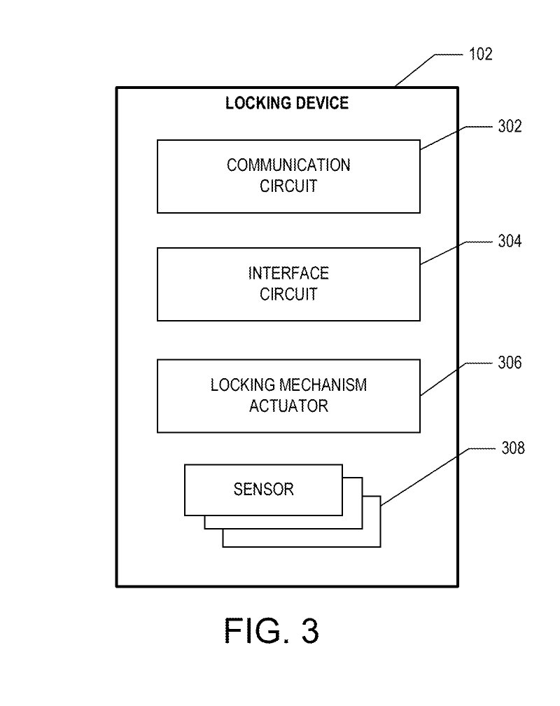

FIG. 3 illustrates several example components of the locking device 102 according to the teachings of the present disclosure. The locking device 102 includes a communication circuit 302 for communicating with the wireless device 116 using one or more protocols such as described above. The locking device 102 also includes an interface circuit 304 for interfacing with an actuator 306 used to lock/unlock the locking mechanism, and one or more sensors 308 configured in the locking device 102. The communication circuit 302 and interface circuit 304 may include any suitable type and combination of circuitry to perform the various features of the locking device 102 described herein. For example, the communication circuit 302 and interface circuit 304 processor that executes instructions stored in a memory, an application specific integrated circuit (ASIC), field programmable gate array (FPGA), discrete electronic components, or any combination thereof.

The actuator 306 is physically coupled to the locking mechanism 206 for selectively holding or releasing the openable member from the container, is controlled by the communication circuit 302 via the interface circuit 304. The sensors 308 may be any suitable type that monitors the operating condition of the locking device 102 and/or detects conditions that may be the result of tampering. For example, one sensor 308 may be a battery sensor that continually monitors the voltage output of batteries that power the wireless communication circuit 302 and interface circuit 304 to detect a low battery condition. As another example, one sensor 308 may include a one-axis, two-axis, or three-axis accelerometer that detects a tampering event of the locking device. As yet another example, one sensor may include a pressure sensor that detects when an inordinate amount of force is placed upon the locking mechanism 206 to disengage the locking mechanism without having first released the lock.

Although FIG. 3 illustrates an example locking device 102, it is contemplated that other embodiments of the locking device 102 may have more, different, or fewer components than those described herein. For example, the locking device 102 may include a sensor 308 to monitor whether or not the locking mechanism is engaged in the receptacle and report this information autonomously or upon demand via a request message from the wireless device 116 or other suitable communication device. For another example, the locking device 102 may include power conditioning circuitry to condition electrical power obtained from either batteries configured in the locking device 102 and/or external electrical power, such as what may be provided by an external power source.

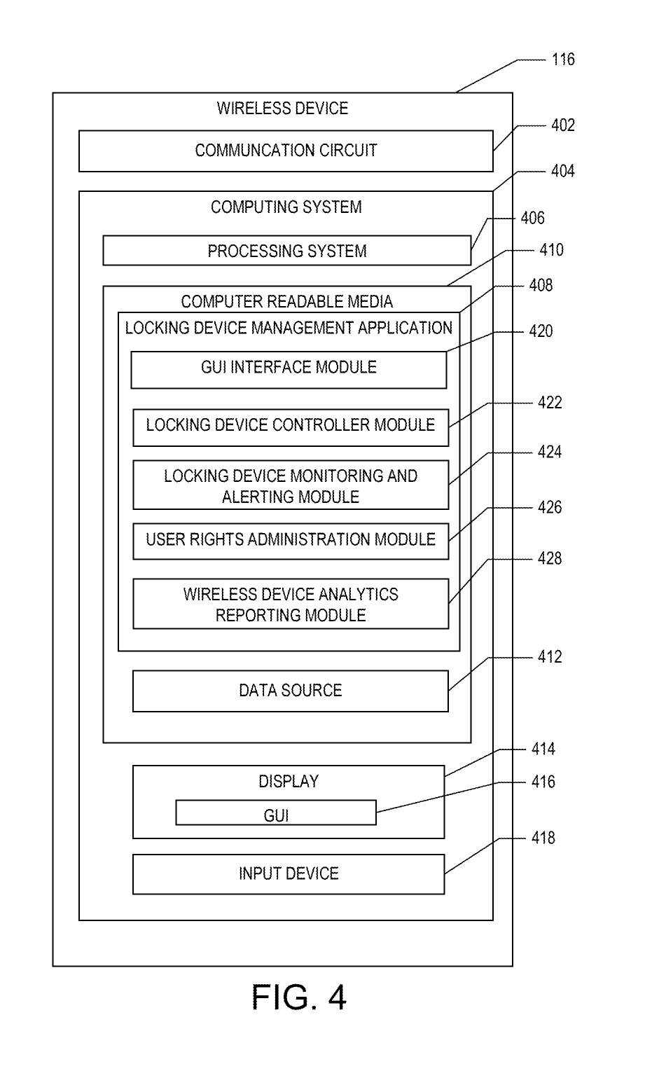

FIG. 4 is a block diagram showing an example wireless device 116 according to the teachings of the present disclosure. In the particular embodiment shown, the wireless device 116 includes a communication circuit 402 for communicating with the locking device 102 and a computing system 404 having a processing system 406 that executes a locking device management application 408 stored in computer readable media 410. For example, the wireless device 116 may include one or more computing devices, such as a smart phone, a tablet computer, or a wearable device that communicates directly with the locking device 102 or communicates with another wireless device (e.g., a smart phone) that communicates with the locking device 102, on which the locking device management application 408 is embodied as a mobile application e.g., mobile app) The wearable device may be a smart watch, a fitness band, jewelry, or another accessory such as a GARMIN™ smart watch, a Pebble smart watch, a SAMSUNG™ Galaxy Gear smart watch, an ANDROID™ based smart watch, an APPLE™ watch, a TIZEN™ smart watch, and others According to one aspect, the locking device management application 408 may be a web application, a native application, and/or a mobile application downloaded from a digital distribution application platform that allows users to browse and download applications developed with mobile software development kits (SDKs) including the App Store and GOOGLE PLAY®, among others. The locking device management application 408 may be installed on the wireless device 106, which may have the iOS operating system or an ANDROID™ operating system, among other operating systems. In other embodiments, the wireless device 116 may include any suitable circuitry for implementing some, most, or all the features of the wireless device 116 described herein.

The processing system 406 includes one or more processors or other processing devices and memory. The one or more processors may process machine/computer-readable executable instructions and data, and the memory may store machine/computer-readable executable instructions and data including one or more applications, including the locking device management application 408. A processor is hardware and memory is hardware. The memory includes random access memory (RAM) and non-transitory memory, e.g., a non-transitory computer-readable medium such as one or more flash disks or hard drives. The non-transitory memory may include any tangible computer-readable medium including, for example, magnetic and/or optical disks, flash drives, and the like.

The wireless device 116 also includes a computer readable media 410 on which the locking device management application 408 and a data source 412 are stored. The wireless device 116 also includes a display 414, such as a computer display, for displaying data and/or a graphical user interface (GUI) 416 that includes visual components of the locking device management application 408. The display 414 can include a cathode-ray tube display, a liquid-crystal display, a light-emitting diode display, a touch screen display, and other displays. The wireless device 116 may also include an input device 418, and may include a mouse, a keyboard, a trackpad, and/or the like. The input device 418 may be included within the display 414 if the display is a touch screen display. The input device 418 allows a user of the wireless device 116 to manipulate the user interface of the locking device management application 408 or otherwise provide inputs. The computer readable media (CRM) 410 may include volatile media, nonvolatile media, removable media, non-removable media, and/or another available media that can be accessed by the wireless device 116. By way of example and not limitation, computer readable media 410 comprises computer storage media and communication media. Computer storage media includes non-transient storage memory/media, volatile media, nonvolatile media, removable media, and/or non-removable media implemented in a method or technology for storage of information, such as computer/machine readable/executable instructions, data structures, program modules, and/or other data. Communication media may embody computer readable instructions, data structures, program modules, or other data and include an information delivery media or system, both of which are hardware.

In general, the processing system 406 executes the locking device management application 408 to generate the GUI 416 on a display 414 of the wireless device 116 in order to receive customized information and input from a user and generate instructions to be transmitted to the locking device 102 for controlling its operation. The locking device management application 408 may be a component of an application and/or service executable by the wireless device 116. For example, the locking device management application 408 may be a single unit of deployable executable code. The locking device management application 408 may also be one application and/or a suite of applications.

A GUI interface module 420 facilitates the receipt of data and/or other communications from the input device 418 of the wireless device 116. In one example, the wireless device 116 generates and executes a graphical user interface (GUI) that displays an interactive display, or other suitable user interface mechanism including one or more selectable fields, editing screens, and the like for displaying status information associated with one or more locking devices 102 and/or receiving instructions and data for manipulating the operation of the locking devices 102. The GUI may be a native and/or web-based GUI that accepts input and provides output. The GUI interface module 420 may send data to other modules of the locking device management application 408 and receive data from other modules of the locking device management application 408.

A locking device controller module 422 communicates with the locking device 102 for locking and unlocking the locking mechanism 206. For example, the locking device controller module 422 may communicate with the GUI interface module 420 to receive input indicating that a user of the wireless device 116 requests that the locking mechanism 206 be locked or unlocked. In such a case, the locking device controller module 422, using the communication module 402, transmits the request to the locking device 102 for locking or unlocking, respectively, the locking mechanism 206.

A locking device monitoring and alerting module 424 monitors the operation of one or more locking devices 102 and generates alerts, such as messages displayed on the GUI 416 indicating that one of the locking devices 102 has failed to operate in some manner, or that a tampering event has been detected. For example, the locking device monitoring and alerting module 424 may receive periodic status messages from a locking device 102 indicating one or more functional characteristics of its respective device, such as battery condition, locked or unlocked status, whether or not the locking device 102 is within range of the wireless device 116, and/or whether a tampering event has been detected by one or more sensors 308 configured on the locking device 102. As an example, the locking device 102 and the wireless device 116 may enable proximity monitoring and determine whether they are in range according to the BLUETOOTH Proximity Profile (PXP). The locking device monitoring and alerting module 424 may process these status messages and display such information for view by a user on the GUI 416. In some cases, the locking device monitoring and alerting module 424 may generate status request messages that may be transmitted to the locking device 102 requesting that the locking device 102 respond by transmitting a status message back to the locking device monitoring and alerting module 424.

A user rights administration module 426 manages access rights to each locking device 102 managed by the application 408 and manages locking device setup information. For example, the user rights administration module 426 may receive user input, via the GUI interface module 420, to setup and configure a locking device 102 for management by the application 408, and store associated configuration information in the data source 412. As an example, the wireless device 116 may send a representation of a unique identifier (e.g., a serial number located on the module) to the locking device 102 to ensure that the user is authorized to use the locking device 102. In a particular example in which the locking device 102 and wireless device 116 communicate via Bluetooth™ protocol, the locking device 102 may be configured for use by being paired with the wireless device 116. After the locking device 102 and wireless device 116 are configured for use, the GUI interface module 420 may display user interface components for receiving and displaying a name for the locking device 102 and may display location information associated with the locking device 102.

In one embodiment, the user rights administration module 426 may provide for multiple user access to each locking device 102 managed by the application 408. For example, once a locking device 102 is configured for use with a first wireless device 116, the user rights administration module 426, in response to user input provided via the GUI interface module 420, transmits a copy of the configuration information for that particular locking device 102 to another wireless device 116. In this manner, a first user may be able to share access rights to the locking device 102 with a second user (e.g., a spouse of the first user) so that both may be able to lock and unlock the locking device 102.

In another embodiment, the user rights administration module 426 may provide for hierarchical access rights to one or multiple wireless devices 116. In an office setting for example in which multiple employees may need to access a particular container with a retrofitted locking device 102, a first wireless device 116 owned by a first user may configure the locking device 102 with administrator privileges. Thereafter, the configuration information may be disseminated to other users with a subset of privileges provided to the first wireless device 116 (e.g., the administrator). The subset of privileges may include any type. For example, while the first wireless device 116 may be allowed unlimited access to the locking device 102, other wireless devices 116 may only be allowed access to locking or unlocking the locking device 102 in a specified period of time, such as during business hours (e.g., 8 a.m. to 5 p.m.).

In yet another embodiment, the user rights administration module 426 may provide for certain access privileges according to one or more groups to which each wireless device 116 is designated to. For example, the first wireless device 116 may designate a first group of wireless devices 116 that, when an attempt is made to unlock a particular locking device 102 by a wireless device 116 assigned to that group, an alert message is generated and transmitted to the wireless device 116 of the first user indicating which wireless device 116 has requested access to the locking device 102 and a time that the access was performed, while a second group of wireless devices 116 may access the locking device 102 with no alert message being generated.

A wireless device analytics reporting module 428 records information about the operation of the locking device 102 in the data source 412, and processes the recorded information to determine one or more analytical characteristics associated with operation of the locking device 102. For example, the wireless device analytics reporting module 428 may process multiple recorded locking and unlocking events that have occurred over an extended period of time (e.g., a six month period of time) to determine whether particular characteristics of the events can be derived, such as a periodicity of the events indicating that the locking device 102 was locked and unlocked at regular, periodic schedule, how often the locking device 102 was locked and unlocked, and other behaviors. The wireless device analytics reporting module 428 may use these characteristics to determine how the locking device 102 is used to ascertain certain character traits of the user, or to determine how well the locking device 102 functions under various operating conditions.

It should be appreciated that the modules described herein are provided only as an example of a computing device that may execute the locking device management application 408 according to the teachings of the present invention, and that other computing devices may have the same modules, different modules, additional modules, or fewer modules than those described herein. For example, one or more modules as described in FIG. 4 may be combined into a single module. As another example, certain modules described herein may be encoded and executed on other computing devices, such as a remote locking device management server that provides one or more management functions for each wireless device 116 that executes the application 408.

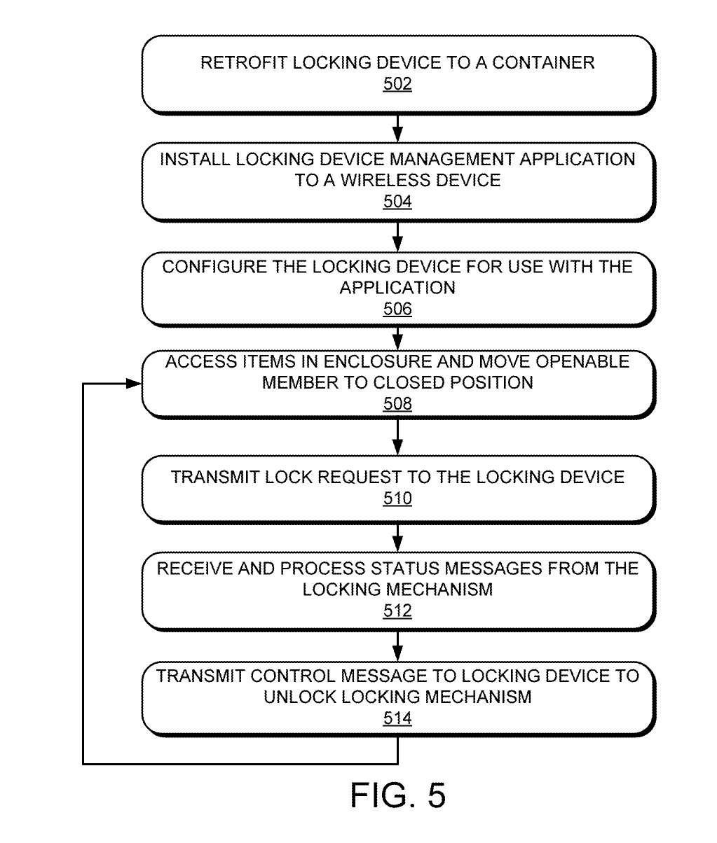

FIG. 5 illustrates an example process that may be performed by the locking device management application 408 according to the teachings of the present disclosure. Although the example process described herein below is directed primarily to a mobile application executed by the wireless device 116, such as a smart phone, other examples contemplate that the process may be embodied with any suitable wireless device 116 for locking and unlocking the locking device 102, which may include, but not limited to a smart watch or other wearable smart device.

In step 502, the locking device 102 is retrofitted to a container. The container may include any suitable device, such as a dresser having one or more drawers, a cupboard having one or more doors, or a stand-alone container, such as a box having a lid that may be opened or closed. Thereafter, the locking device management application 408 is installed or otherwise loaded onto a wireless device, such as a smart phone or tablet computer in step 504.

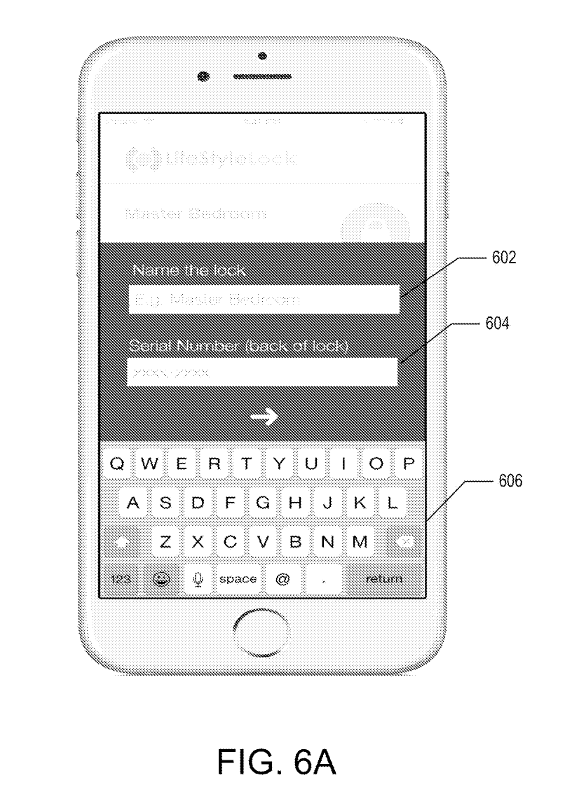

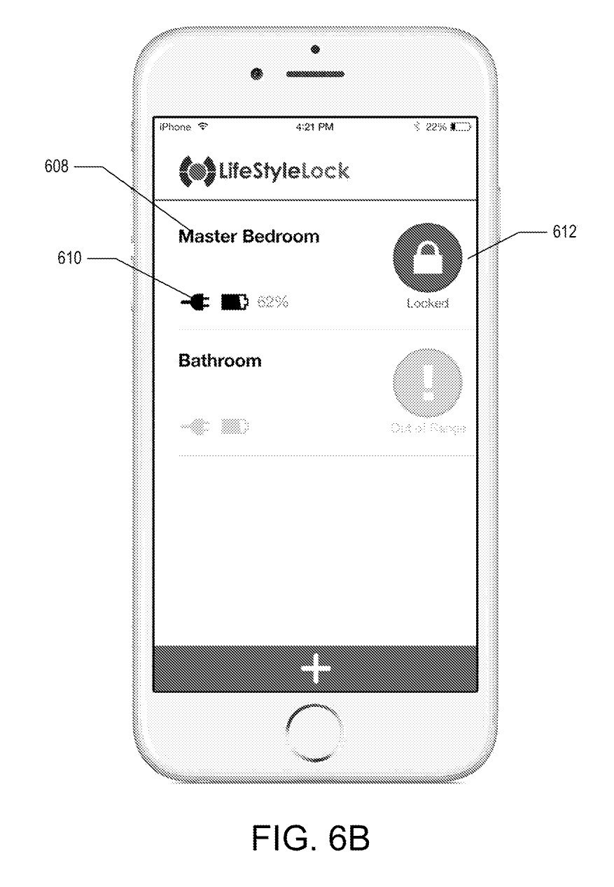

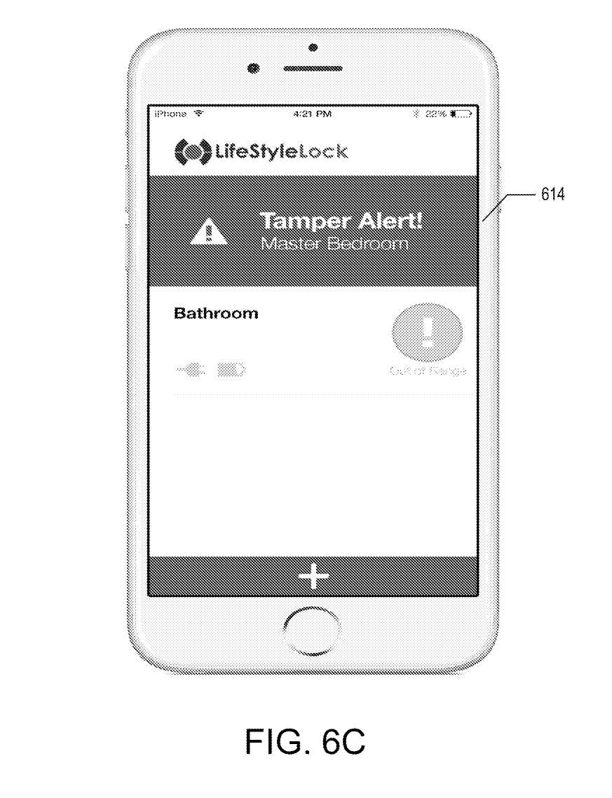

In step 506, the locking device 102 is configured for use with the application 408. For example, once the wireless device 116 is brought within range of the locking device 102, the application 408 may generate a locking device configuration screen (FIG. 6A) in which a name entry field 602 and a serial number entry field 604 may be displayed for entering a name and a serial number, respectively, using a keypad 606. To ensure validity, the application 408 may compare the entered serial number with serial number information received from the locking device 102, such as via one or more beacon messages transmitted by the locking device 102 as the configuration process is performed. The name may be any combination of alpha-numeric or other characters entered by the user, such as one that is generally representative of the location of the locking device 102. Examples of such names may include bedroom to represent placement of the locking device 102 in a bedroom, or bathroom to represent its placement in a bathroom of a house.

In step 508, items are accessed within the enclosure of the container followed by movement of the openable member of the container to the closed position. Thereafter, the application 408 receives input from the GUI 416 requesting that the locking mechanism 206 be moved to the locked position, and in response, transmits a lock request message to the locking device 102 to lock the locking mechanism 206 in step 510. In one embodiment, the application 408 may receive a signal from a sensor configured on the locking mechanism 206 to detect that the openable member (e.g., drawer 106) has been moved from the closed position and in response, control the actuator 306 to lock the locking mechanism 206. In this manner, the openable member may be automatically locked without any specific user request to lock the openable member.

In step 512, the application 408 receives and processes status messages received from the locking device 102. The status messages transmitted by the locking device 102 may be autonomously transmitted (e.g., periodic beacon messages), or may be transmitted in response to a request message from the wireless device 116. When the status messages are received, they may be displayed on the GUI 416 by the application 408. For example, the application 408 may generate a status display screen (FIG. 6B) that displays status information for each locking device 102 configured for use with the application 408. The particular status display screen shows that two devices have been configured for use with the application 408, namely a first locking device 102 retrofitted on a container in a master bedroom of a home, and a second locking device 102 retrofitted on another container in a bathroom of the home. Although only two locking devices are shown, it should be appreciated that any quantity of locking devices may be configured for use with the application 408 and displayed on the status display screen.

The status display screen may display any suitable type of information for view by the user. In the particular example shown, the status display screen displays the name icon 608, an electrical power icon 610, and a lock condition icon 612. The name icon 608 displays the name of its respective locking device 102. The electrical power icon 610 displays the condition of the electrical power source, such as whether external electrical power is operational, and the discharge rate of any batteries configured in the locking device 102. The lock condition icon 612 displays information associated with whether or not the locking device 102 is in a locked or unlocked condition.

The status messages from the locking device 102 may also include alert messages generated in response to sensors detecting one or more fault conditions of the locking device 102. For example, the application 408 may generate a tamper alert screen (FIG. 6C) that displays an alert message 614 when a tamper event has been detected. For example, the locking device 102 may include an accelerometer sensor providing signals that are processed by the interface circuitry 304 of the locking device to, when a specified amount of physical movement has been detected, generate and transmit a tamper message to the wireless device 116 for display on the tamper alert screen. Other types of alert messages may be displayed. For example, an alert message may be generated when the battery power goes below a certain specified level, or when a specified quantity of unsuccessful access attempts are received within a specified period of time.

In step 514, the application 408 receives signals from the GUI 416 requesting that the locking mechanism be unlocked, and generates an unlock request message that is transmitted to the locking device 102. In response, the locking device 102 actuates the actuator 306 to release the lock thus allowing the openable member to be opened. When the openable member of the container is closed, processing continues at step 508 in which the openable container is again locked to secure items within the enclosure.

Processing continues for additional unlocking and locking cycles of the locking device 102. Nevertheless, when use of the locking device 102 and application 408 are no longer needed or desired, the process ends.

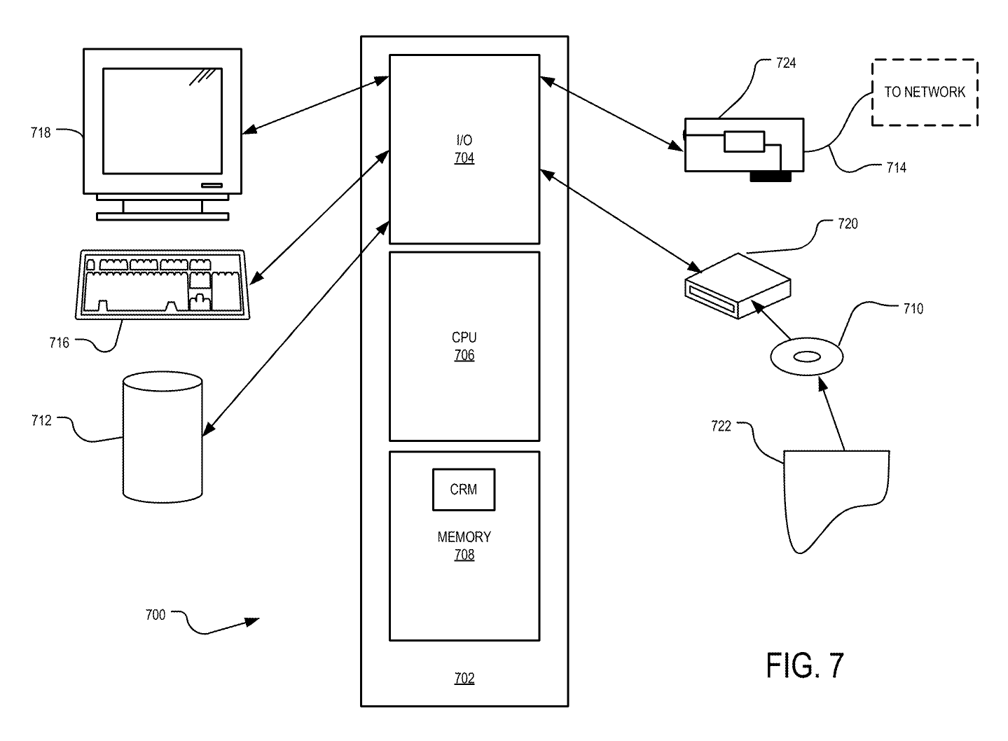

FIG. 7 illustrates an example computing system 700 that may implement various systems, such as the locking device 102 and the wireless device 116, and methods discussed herein, such as process 500. A general purpose computer system 700 is capable of executing a computer program product to execute a computer process. Data and program files may be input to the computer system 700, which reads the files and executes the programs therein such as the locking device management application 408. Some of the elements of a general purpose computer system 700 are shown in FIG. 7 wherein a processor 702 is shown having an input/output (I/O) section 704, a central processing unit (CPU) 706, and a memory section 708. There may be one or more processors 702, such that the processor 702 of the computer system 700 comprises a single central-processing unit 706, or a plurality of processing units, commonly referred to as a parallel processing environment. The computer system 700 may be a conventional computer, a server, a distributed computer, or any other type of computer, such as one or more external computers made available via a cloud computing architecture. The presently described technology is optionally implemented in software devices loaded in memory 708, stored on a configured DVD/CD-ROM 710 or storage unit 712, and/or communicated via a wired or wireless network link 714, thereby transforming the computer system 700 in FIG. 7 to a special purpose machine for implementing the described operations.

The memory section 708 may be volatile media, nonvolatile media, removable media, non-removable media, and/or other media or mediums that can be accessed by a general purpose or special purpose computing device. For example, the memory section 708 may include non-transitory computer storage media and communication media. Non-transitory computer storage media further may include volatile, nonvolatile, removable, and/or non-removable media implemented in a method or technology for the storage (and retrieval) of information, such as computer/machine-readable/executable instructions, data and data structures, engines, program modules, and/or other data. Communication media may, for example, embody computer/machine-readable/executable, data structures, program modules, algorithms, and/or other data. The communication media may also include an information delivery technology. The communication media may include wired and/or wireless connections and technologies and be used to transmit and/or receive wired and/or wireless communications.

The I/O section 704 is connected to one or more user-interface devices (e.g., a keyboard 716 and a display unit 718), a disc storage unit 712, and a disc drive unit 720. Generally, the disc drive unit 720 is a DVD/CD-ROM drive unit capable of reading the DVD/CD-ROM medium 710, which typically contains programs and data 722. Computer program products containing mechanisms to effectuate the systems and methods in accordance with the presently described technology may reside in the memory section 704, on a disc storage unit 712, on the DVD/CD-ROM medium 710 of the computer system 700, or on external storage devices made available via a cloud computing architecture with such computer program products, including one or more database management products, web server products, application server products, and/or other additional software components. Alternatively, a disc drive unit 720 may be replaced or supplemented by a floppy drive unit, a tape drive unit, or other storage medium drive unit. The network adapter 724 is capable of connecting the computer system 700 to a network via the network link 714, through which the computer system can receive instructions and data. Examples of such systems include personal computers, Intel or PowerPC-based computing systems, AMD-based computing systems, ARM-based computing systems, and other systems running a Windows-based, a UNIX-based, a mobile operating system, or other operating system. It should be understood that computing systems may also embody devices such as Personal Digital Assistants (PDAs), mobile phones, tablets or slates, multimedia consoles, gaming consoles, set top boxes, etc.

When used in a LAN-networking environment, the computer system 700 is connected (by wired connection and/or wirelessly) to a local network through the network interface or adapter 724, which is one type of communications device. When used in a WAN-networking environment, the computer system 700 typically includes a modem, a network adapter, or any other type of communications device for establishing communications over the wide area network. In a networked environment, program modules depicted relative to the computer system 700 or portions thereof, may be stored in a remote memory storage device. It is appreciated that the network connections shown are examples of communications devices for and other means of establishing a communications link between the computers may be used.

In an example implementation, source code executed by the locking device 102 and the wireless device 116, a plurality of internal and external databases are stored in memory of the locking device 102 or memory of the wireless device 116 including data source 412, or other storage systems, such as the disk storage unit 712 or the DVD/CD-ROM medium 710, and/or other external storage devices made available and accessible via a network architecture. The source code executed by the locking device 102 and the wireless device 116 may be embodied by instructions stored on such storage systems and executed by the processor 702.

Some or all of the operations described herein may be performed by the processor 702, which is hardware. Further, local computing systems, remote data sources and/or services, and other associated logic represent firmware, hardware, and/or software configured to control operations the system 100 and/or other components. Such services may be implemented using a general purpose computer and specialized software (such as a server executing service software), a special purpose computing system and specialized software (such as a mobile device or network appliance executing service software), or other computing configurations. In addition, one or more functionalities disclosed herein may be generated by the processor 702 and a user may interact with a Graphical User Interface (GUI) using one or more user-interface devices (e.g., the keyboard 716, the display unit 718, and the user devices 704) with some of the data in use directly coming from online sources and data stores. The system set forth in FIG. 7 is but one possible example of a computer system that may employ or be configured in accordance with aspects of the present disclosure.

In the present disclosure, the methods disclosed may be implemented as sets of instructions or software readable by a device. Further, it is understood that the specific order or hierarchy of steps in the methods disclosed are instances of example approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a non-transitory machine-readable medium having stored thereon executable instructions, which may be used to program a computer system (or other electronic devices) to perform a process according to the present disclosure. A non-transitory machine-readable medium includes any mechanism for storing information in a form (e.g., software, processing application) readable by a machine (e.g., a computer). The non-transitory machine-readable medium may include, but is not limited to, magnetic storage medium (e.g., floppy diskette), optical storage medium (e.g., CD-ROM); magneto-optical storage medium, read only memory (ROM); random access memory (RAM); erasable programmable memory (e.g., EPROM and EEPROM); flash memory; or other types of medium suitable for storing electronic executable instructions.

The description above includes example systems, methods, techniques, instruction sequences, and/or computer program products that embody techniques of the present disclosure. However, it is understood that the described disclosure may be practiced without these specific details.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

While the present disclosure has been described with reference to various embodiments, it will be understood that these embodiments are illustrative and that the scope of the disclosure is not limited to them. Many variations, modifications, additions, and improvements are possible. More generally, embodiments in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

What is claimed is:

1. A lockable enclosure system comprising:
a locking mechanism to be retrofitted to a container having an enclosure and an openable member that selectively provides access to the enclosure, the locking mechanism selectively movable from a locked position in which the openable member is held in a closed position to an unlocked position in which the openable member is allowed to be opened to provide access to the enclosure; and
a wireless communication unit to selectively move the locking mechanism between the locked position and the unlocked position in response to wireless signals received from a wireless device of a user.

2. The lockable enclosure system of claim 1, wherein the container comprises at least one of a dresser with a drawer, a box with a lid, a cupboard with a door, a two-door cabinet, a refrigerator, a wine cabinet, a job site box, and a food cooler.

3. The lockable enclosure system of claim 1, wherein the locking device is concealed from view on the container.

4. The lockable enclosure system of claim 1, wherein the locking mechanism comprises at least one of an electromagnet, an electro-permanent magnet, and a ball-detent solenoid.

5. The lockable enclosure system of claim 1, wherein the wireless device communicates directly with the locking device without the use of a communication network.

6. The lockable enclosure system of claim 1, wherein the wireless device communicates with the locking device through a communication network.

7. The lockable enclosure system of claim 1, wherein the wireless device communicates with the locking device using a protocol comprising at least one of an unlicensed communication, a Bluetooth™ protocol, a Bluetooth™ low energy (BLE) protocol, a Wi-Fi protocol, a ZigBee protocol, and a Z-Wave protocol.

8. The lockable enclosure system of claim 1, further comprising a wireless device comprising at least one memory for storing an application that, when executed by at least one processor, is executed to transmit a wireless lock or unlock signal to lock or unlock, respectively, the locking mechanism.

9. A container locking system comprising:
a wireless device comprising at least one memory for storing an application that when executed by at least one processor, is executed to:
transmit a wireless lock or unlock signal to lock or unlock, respectively, a locking mechanism of a locking device, the locking mechanism retrofitted to a container having an enclosure and an openable member that selectively provides access to the enclosure,
wherein the locking mechanism is selectively movable from a locked position in which the openable member is held in a closed position to an unlocked position in which the openable member is allowed to be opened to provide access to the enclosure.

10. The container locking system of claim 9, wherein the application is further executed to transmit access rights information to one or more other wireless devices, the access rights information allowing the other wireless devices to transmit the wireless lock or unlock signal to the locking device for locking or unlocking, respectively, the locking mechanism.

11. The container locking system of claim 10, wherein the application is further executed to provide one or more hierarchal access rights to at least one of the other wireless devices, the hierarchal access rights comprising a subset of the access rights of the locking device.

12. The container locking system of claim 10, wherein the application is further executed to provide certain access privileges to each of the other wireless devices according to a group that each of the other wireless devices are assigned.

13. The container locking mechanism of claim 10, wherein the application is further executed to store locking and unlocking events performed by the locking device, and perform one or more analytics processes using the stored locking and unlocking events.

14. The container locking mechanism of claim 9, wherein the application is further executed to receive one or more status messages from the locking device, and display information associated with the status messages on a display of the wireless device.

15. The container locking mechanism of claim 9, wherein at least the status message comprises a tampering event message indicating that the locking device has been tampered with.

16. The lockable enclosure system of claim 9, wherein the wireless device communicates with the locking device using a protocol comprising at least one of an unlicensed communication, a Bluetooth™ protocol, a Bluetooth™ low energy (BLE) protocol, a Wi-Fi protocol, a ZigBee protocol, and a Z-Wave protocol.

17. A container locking method comprising:
transmitting, using instructions stored in at least one memory and executed by at least one processor, a wireless lock or unlock signal to lock or unlock, respectively, a locking mechanism of a locking device, the locking mechanism retrofitted to a container having an enclosure and an openable member that selectively provides access to the enclosure; and
moving the locking mechanism between a locked position in which the openable member is held in a closed position and an unlocked position in which the openable member is allowed to be opened to provide access to the enclosure.

18. The container locking method of claim 17, further comprising transmitting access rights information to one or more other wireless devices, the access rights information allowing the other wireless devices to transmit the wireless lock or unlock signal to the locking device for locking or unlocking, respectively, the locking mechanism.

19. The container locking method of claim 18, further comprising providing one or more hierarchal access rights to at least one of the other wireless devices, the hierarchal access rights comprising a subset of the access rights of the locking device.

20. The container locking method of claim 18, further comprising providing certain access privileges to each of the other wireless devices according to a group that each the other wireless devices are assigned.

21. The container locking method of claim 18, further comprising:
storing locking and unlocking events performed by the locking device; and
performing one or more analytics processes using the stored locking and unlocking events.

22. The container locking method of claim 17, further comprising retrofitting the locking mechanism to the container

23. A lockable enclosure system comprising:
a locking device comprising:
a locking mechanism to be retrofitted to a container having an enclosure and an openable member that selectively provides access to the enclosure, the locking mechanism selectively movable from a locked position in which the openable member is held in a closed position to an unlocked position in which the openable member is allowed to be opened to provide access to the enclosure; and
a wireless communication unit to selectively move the locking mechanism between the locked position and the unlocked position in response to wireless signals received from a wireless device of a user; and
a wireless device comprising at least one memory for storing an application that when executed by at least one processor, is executed to transmit a wireless lock or unlock signal to lock or unlock, respectively, a locking mechanism of a locking device, the locking mechanism retrofitted to a container having an enclosure and an openable member that selectively provides access to the enclosure.
